(19) United States
(12) Patent Application Publication
(10) Pub. No.: US 2023/0395874 A1
(43) Pub. Date: Dec. 7, 2023

(54) ELECTROSPUN POLYMERS FOR CATHODE-POLYMER-ELECTROLYTE-INTERFACES (CPEI) TO ENABLE SOLID-STATE ELECTROLYTES IN LI-ION BATTERIES

(71) Applicant: Ionic Materials, Inc., Woburn, MA (US)

(72) Inventors: Ariel Jackson, Medford, MA (US); Mohamed Taggougui, Acton, MA (US); Ahmed Al-Obeidi, Wakefield, MA (US); Andrew Leitner, Lynn, MA (US); Zhiyong Meng, Portland, OR (US); Joseph X. Adiletta, Cambridge, MA (US); Vikram Sharma, Melrose, MA (US)

(21) Appl. No.: 18/204,628

(22) Filed: Jun. 1, 2023

Related U.S. Application Data
(60) Provisional application No. 63/347,803, filed on Jun. 1, 2022.
(60) Provisional application No. 63/349,801, filed on Jun. 7, 2022.

(51) Int. Cl. H01M 10/42; H01M 10/0562; H01M 4/04; H01M 10/0525

(52) U.S. Cl. CPC H01M 10/4235; H01M 10/0562; H01M 2004/021; H01M 10/0525; H01M 2300/0068; H01M 4/0404

(57) ABSTRACT

Electrospun polymers are disclosed for use in lithium-ion electrochemical cells. The disclosed electrospun polymers may be positioned between the cathode and a solid-state electrolyte to enhance the Li-ion cell's performance, safety, and resiliency to mechanical failure.

### CROSS-REFERENCE TO RELATED APPLICATIONS

This application claims the benefit of U.S. Provisional Patent Application No. 63/347,803, titled ELECTROSPUN POLYMERS FOR CATHODE-POLYMER-ELECTROLYTE-INTERFACES (CPEI) TO ENABLE SOLID-STATE ELECTROLYTES IN LI-ION BATTERIES, filed Jun. 1, 2022, and U.S. Provisional Patent Application No. 63/349,801, titled ELECTROSPUN POLYMERS FOR CATHODE-POLYMER-ELECTROLYTE-INTERFACES (CPEI) TO ENABLE SOLID-STATE ELECTROLYTES IN LI-ION BATTERIES, filed Jun. 7, 2022, the disclosures of which are herein incorporated by reference in their entireties.

### FIELD OF TECHNOLOGY

The present disclosure is in the field of electrospun polymers, and more particularly, in the field of an electrospun polymer layer used to modify the interface of an electrode in order to enhance the Li-ion cell's performance, safety, and resiliency to mechanical failure.

### BACKGROUND

Solid state Li-ion batteries require good adhesion between the cathode and ceramic electrolyte, and physical separation, to protect from electrochemical degradation. Any adhesive must not significantly impact the electrochemical performance of the battery cell. Namely, it must be stable at high voltages, have low Li⁺ ionic resistance, low moisture content, and allow any liquid electrolyte or catholyte to permeate in order to access the porous cathode.

### SUMMARY

According to an aspect of the present disclosure, a battery is provided. The battery includes an electrolyte, a cathode, and an electrospun polymer layer positioned between the cathode and the electrolyte.

In some embodiments, the electrospun polymer layer has a thickness of 5 microns or less. In these and other embodiments, the electrospun polymer layer comprises one or more polymers selected from the group consisting of: thermoset polyurethane comprising one or more prepolymers, and a chain extender. In select embodiments, the electrospun polymer layer includes a first layer and a second layer, and the first layer includes a polymer that is stable against the cathode but reactive with the electrolyte, and the second layer includes a polymer that is stable against the electrolyte but reactive with the cathode. In some such embodiments, the second layer also includes a tackifier. In other embodiments, the electrospun polymer layer includes a polymer that is stable against both the cathode and the electrolyte. The electrospun polymer layer may be formed directly on the cathode, in some embodiments.

In various embodiments, the electrolyte is a solid-state electrolyte. In these and other embodiments, the electrospun polymer layer is formed directly on the solid-state electrolyte. The solid-state electrolyte may be selected from the group consisting of: lithium lanthanum zirconium oxide (LLZO), LLTO, a sulfide, LATP, and LiPON. In some embodiments, the electrospun polymer layer is formed on a release liner and then transferred to a surface of the cathode or a surface of the solid-state electrolyte. In these and other embodiments, the cathode is a porous cathode containing cathode active material and a polymer or a liquid electrolyte. In select embodiments, the battery also includes a cathode current collector in contact with the cathode. In these and other embodiments, the battery also includes an anode adjacent to the electrolyte. In some such embodiments, the anode includes lithium ions. In these and other embodiments, the battery also includes an anode current collector in contact with the anode. Various other embodiments may be apparent to those skilled in the art upon consideration of the subject disclosure.

### BRIEF DESCRIPTION OF THE DRAWINGS

FIG. 1A shows a schematic diagram of an electrochemical cell with a polymer layer positioned between the cathode and a solid-state electrolyte;

FIG. 1B shows a schematic diagram of an embodiment in which an electrospun polymer layer permits liquid electrolyte to percolate directly into a cathode through pores between the polymer fibers;

FIG. 2 shows an image of an electrospun polymer positioned at the interface of a cathode and an electrolyte;

FIG. 3 shows a photo of an experimental setup used to create an example electrospun polymer configured in accordance with embodiments of the subject disclosure;

FIG. 4 shows an external view of the electrospinning machine used to form an example electrospun polymer;

FIG. 5 shows a cathode coated with an electrospun polymer as compared to a cathode without electrospun polymer;

FIGS. 6A and 6B show SEM images of an electrospun polymer configured in accordance with an embodiment of the present disclosure;

FIGS. 7A and 7B show SEM images of an electrospun polymer configured in accordance with an embodiment of the present disclosure;

FIGS. 8A and 8B provide cross-section SEM images of the highest applied loading for the illustrative example;

FIG. 9 shows an uncoated cathode after soaking in electrolyte;

FIGS. 10A and 10B show an electrospun polymer layer configured in accordance with an embodiment of the present disclosure; and

FIG. 11 shows a cathode used in a previous formulation.

### DETAILED DESCRIPTION

Embodiments of the present disclosure include an electrospun polymer layer used to modify the interface of an electrode in order to enhance the Li-ion cell's performance, safety, and resiliency to mechanical failure, thereby enabling solid-state Li-ion platforms.

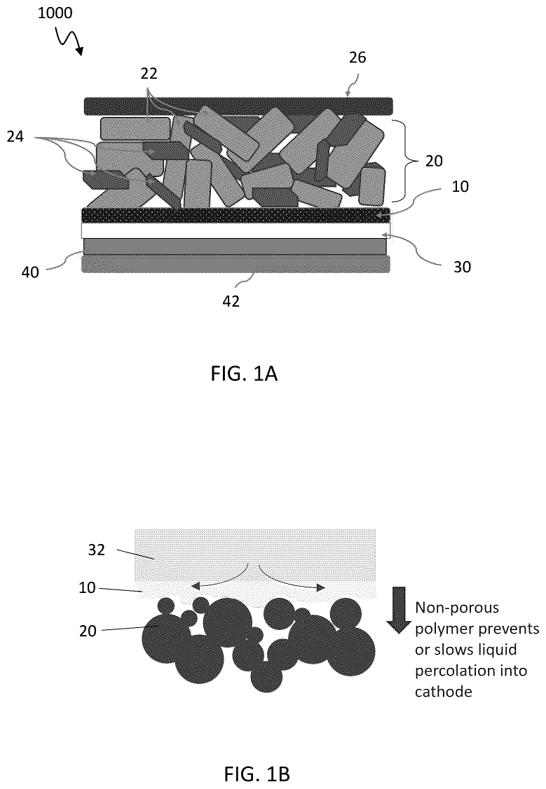

Presently, solid-state Li-ion batteries' performance suffers due to limitations inherent in the ceramic solid-state electrolytes. Cracking of the solid-state electrolyte can frequently occur during normal operation. The calendar life of the battery is reduced with high nickel content cathodes that reach at least 4.35 V vs. Li/Li⁺, because some solid-state electrolytes are electrochemically unstable at these potentials. Additionally, residual lithium carbonate in the cathodes can act as a poison to solid-state electrolytes when they are in physical contact. A polymer layer between the cathode and solid-state electrolyte, such as shown in FIG. 1A, can address these shortcomings.

As shown in FIG. 1A, the electrochemical cell 1000 may include a polymer layer 10 positioned to serve as an electrolyte interface. As discussed in more detail herein, the polymer layer 10 may be an electrospun cathode polymer. A cathode 20 is in contact with the polymer layer 10. As shown in FIG. 1A, the cathode 20 is a porous cathode containing cathode active material 22 and polymer or liquid electrolyte (catholyte) 24. A cathode current collector 26 may also be included in the electrochemical cell 1000.

The electrochemical cell 1000 of FIG. 1A shows a solid-state electrolyte 30 abutting the polymer layer 10. The solid-state electrolyte may be implemented with any suitable solid-state electrolyte, such as lithium lanthanum zirconium oxide (LLZO), LLTO, sulfide, LATP, LiPON, or others. As shown in FIG. 1A, anode 40 is positioned directly adjacent to the solid-state electrolyte 30. The anode 40 may be formed of lithium metal or other suitable anode active materials. If desired, the electrochemical cell 1000 may also include an anode current collector 42, as shown in FIG. 1A.

For a polymer layer 10 to traditionally meet its requirements, there are two general approaches for a cathode interface layer: non-porous, ionically conductive, or highly porous, leveraging liquid electrolyte. Introducing porosity via electrospinning can address many issues inherent with polymer layers.

Presently, no adhesive can be used on the cathode's active surface in Li-ion batteries with ceramic solid-state electrolytes to bind the ceramic electrolyte to the porous cathode. This means that the cell may be prone to fail due to failure of seals/gaskets, cracking in the ceramic electrolyte from shock and vibration, and/or volume change induced stress during cycling, all of which could allow permeation of Li dendrites to short the cell.

In some cases, a polymer gel network with a solvent and a Li-salt may be used to as a bonding agent between the ceramic electrolyte and cathode. However, while a spin-coating may be used to achieve thin layers, this is not a feasible coating method for a porous cathode with surface roughness. Additionally, many of the polymers used in this way (e.g. PAN, PEO, PVDF) are not stable with the ceramic electrolyte and/or high voltage cathode materials.

Embodiments of the present disclosure overcome these issues. According to one implementation of the present disclosure, a single layer electrospun coating, approx. 5 micron or less, is applied directly to the cathode. This layer comprises, consists essentially of, or consists of a polymer that is stable against both the cathode and any solidstate electrolyte. In select embodiments, no tackifiers have been added to the electrospun polymer to increase its adhesion when in contact with the solid-state electrolyte.

According to one implementation of the present disclosure, while many polymer coatings are too thick (>20 μm), electrospinning can permit the depositing of <1 μm layers. Further, while polymer coating swells (˜300%) when exposed to liquid electrolyte, traditionally leading to mechanical deformation of the cathode, polymer coatings manufactured via electrospinning can result in porosity between the electrospun fibers to accommodate the polymer swelling, reducing interface stress and deformation. Adhesion can be achieved through polymer selection and/or inclusion of tackifier additives.

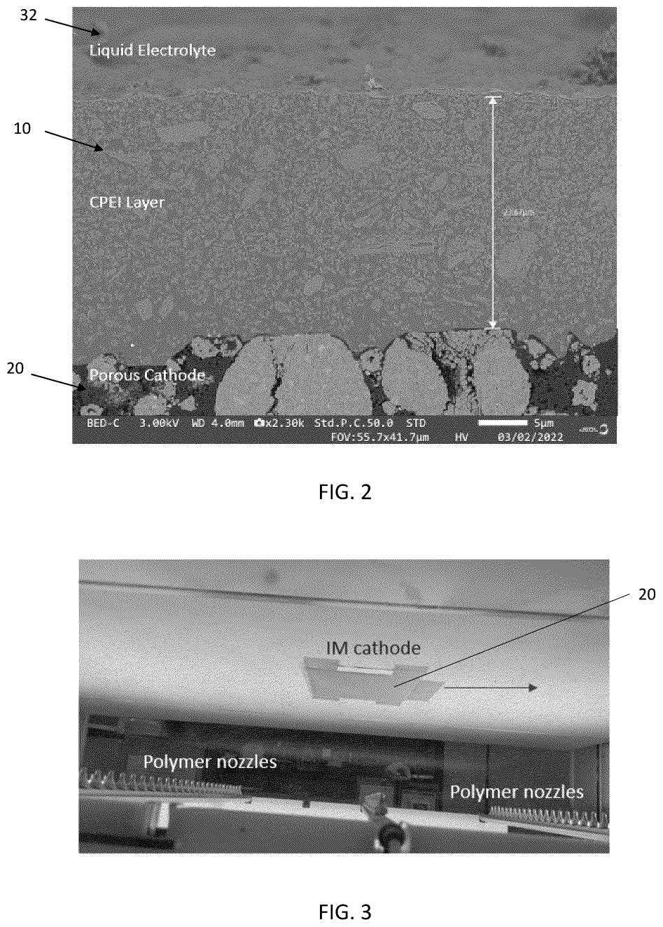

While traditional polymer layers may include resistances slightly above target (7-25 Ω/cm²), according to one implementation of the present disclosure, electrospinning permits added porosity, eliminating tortuosity of Li+diffusion in polymer; as, where there is a semi-resistive polymer, the thickness is significantly reduced, resulting in lower resistance due to added porosity and a thinner layer. According to another implementation of the present disclosure, while polymer coating traditionally blocks percolation of electrolyte into porous cathode, electrospinning allows for the liquid electrolyte to percolate directly into the cathode through the pores between the polymer fibers. Thereby, liquid electrolyte can easily access the porous cathode by percolating through the pores between the polymer fibers. This can be seen in FIG. 1B and FIG. 2. In FIG. 2, the electrospun polymer 10 is positioned at the interface of the cathode 20 and the electrolyte 30. Herein, the term “cathode-polymer-electrolyte-interfaces” may be abbreviated as “CPEI.”

FIG. 1B shows a schematic diagram of an embodiment in which an electrospun polymer layer 10 permits a liquid electrolyte 32 to percolate directly into a cathode 20 through pores between the polymer fibers. FIG. 2 shows an image of an electrospun polymer 10 positioned at the interface of a cathode 20 and a liquid electrolyte 32.

A polymer adhesive that meets these criteria may also provide other benefits including:
protection against cathode or ceramic electrolyte degradation due to physical contact between the two, protection against cell degradation due to shock and vibration, and compliance for volume changes that occurs from lithium plating and deplating on the anode side of the cell.

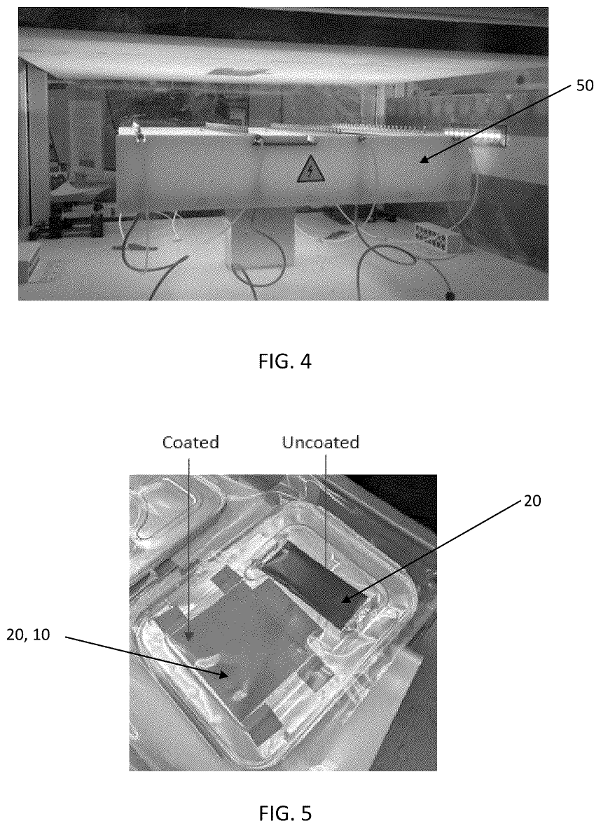

According to illustrative examples, a trial was conducted with five different loadings of a polymer applied via electrospinning, including a factor of 9×from lowest to highest coating amount. Thermoplastic Polyurethane (Elastollan™ from BASF) was used in coating amounts of 0.1 g/m², 0.3 g/m², 0.5 g/m², 0.7 g/m², and 0.9 g/m² for the illustrative examples. In these illustrative examples, electrospinning equipment was not located in a dry room, and exposure time of cathodes was intentionally limited to only a few minutes. FIGS. 3, 4, and 5 display an overview of the environment used to create the illustrative examples. FIG. 3 shows how the cathode 20 was positioned in the electrospinning machine. FIG. 4 shows an external view of the electrospinning machine 50. FIG. 5 shows a cathode 20 coated with an electrospun polymer 10 as compared to a cathode 20 without electrospun polymer.

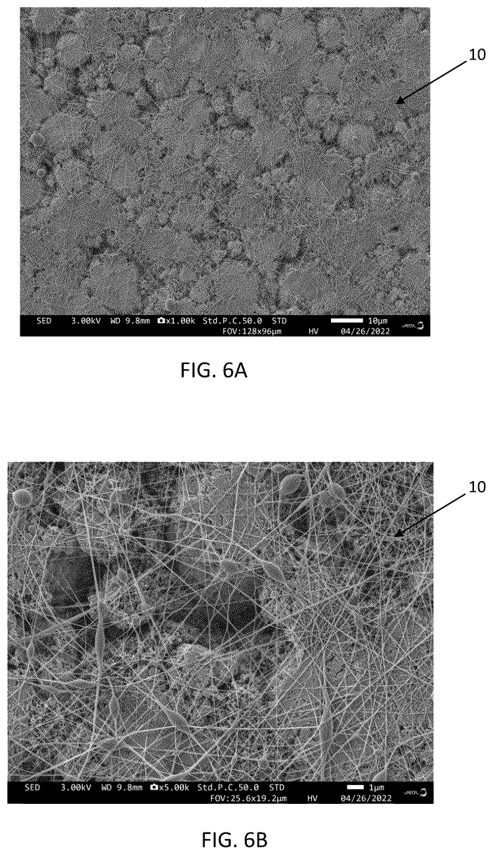

FIGS. 6A and 6B provide SEM images of the lowest applied loading for the illustrative examples (0.1 g/m²).

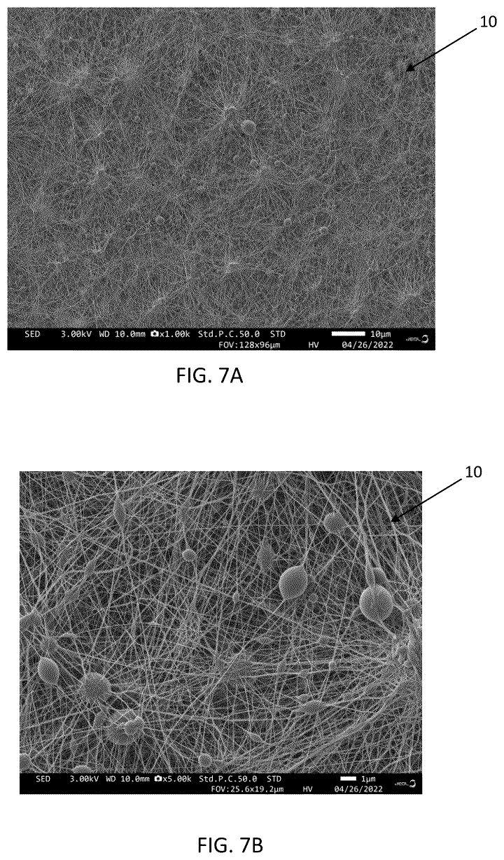

FIGS. 7A and 7B provide SEM images of the highest applied loading for the illustrative examples (0.9 g/m²).

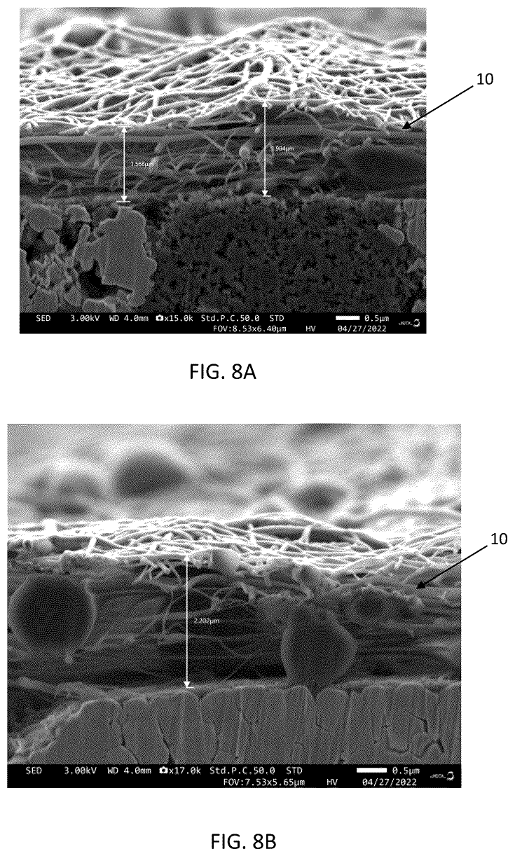

FIGS. 8A and 8B provide cross-section SEM images of the highest applied loading for the illustrative examples (0.9 g/m²).

According to the illustrative examples, reduced electrode deformation was found in polymer layers treated with an electrospun method. This resulted in significantly reduced electrode curling compared to other formulations, as the cathodes with electrospun coatings used in the illustrative examples curl no more than a baseline uncoated cathode when soaked in electrolyte. While some bowing may occur, after applying some pressure, the electrode behaves normally. According to the illustrative examples, no complications should occur when constructing coin cells.

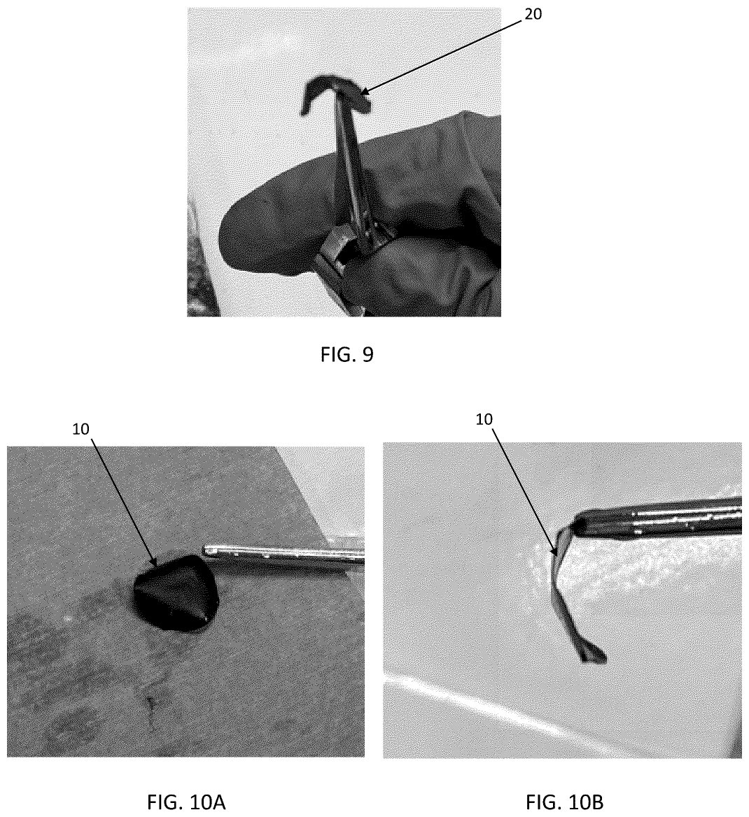

FIG. 9 shows a baseline uncoated cathode 20 after soaking in electrolyte.

FIGS. 10A and 10B show an electrospun polymer layer 10 used in the illustrative examples.

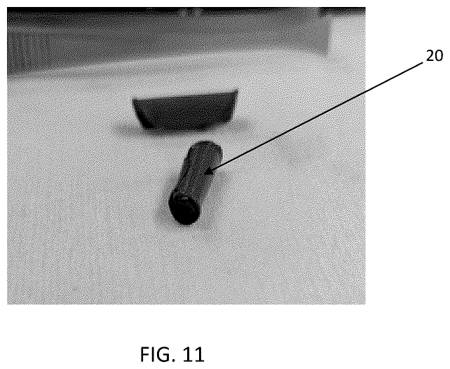

FIG. 11 shows a cathode 20 used in a previous formulation.

According to another implementation of the present disclosure, a multilayer electrospun coating, approx. 5 micron or less in total, may be applied to the cathode. The first layer comprises, consists essential of, or consists of a polymer that is stable against the cathode, but reacts with the solid-state electrolyte, such as Thermoplastic Polyurethane (Elastollan™ from BASF), and/or Thermoset Polyurethane (Imuthane™ PET-60D, PET-95A from COIM with diethylene glycol). The second layer comprises, consists essentially of, or consists of a polymer that is stable against the solid-state electrolyte, but reacts with the cathode. This second layer may or may not contain tackifiers (polyisobutylene, poly(butyl acrylate), etc.) in order to increase its adhesion when in contact with the solid-state electrolyte.

According to another implementation of the present disclosure, a single layer electrospun coating, approx. 5 micron or less, may be applied to the cathode. This layer comprises, consists essentially of, or consists of a polymer that is stable against both the cathode and solid-state electrolyte, eliminating the need for multi-layer deposition, such as Thermoplastic Polyurethane (Elastollan™ from BASF), and/or Thermoset Polyurethane (Imuthane™ PET-60D, PET-95A from COIM with diethylene glycol). This layer may include the addition of tackifiers to increase its adhesion when in contact with the solid-state electrolyte.

According to another implementation of the present disclosure, the electrospun polymer may be coated on the ceramic electrolyte, which is brought into contact and adhered to the cathode during cell assembly.

According to another implementation of the present disclosure, a single or multilayer coating may be electrospun onto a release liner and then transferred to the porous cathode surface or solid-state electrolyte surface before the cell is assembled.

According to another implementation of the present disclosure, the electrospun polymer may be coated onto a conventional battery separator, which is then placed between cathode and solid-state electrolyte during cell construction. Each side of the separator may be electrospun with the same polymer or different polymers to tailor them specifically to the cathode and solid- state electrolyte sides.

According to another implementation of the present disclosure, a partially cured polymer may be electrospun onto the cathode (or any of the other substrates previously mentioned), and then fully cured after coming into contact with the ceramic electrolyte. In some embodiments, the partially cured polymer may comprise, consist essentially of, or consist of Thermoset Polyurethane composed of Prepolymers (e.g., Imuthane™ PET-60D or PET-95A from COIM) and Chain Extender (Diethylene Glycol or Butanediol) cured by slight heating. The delayed full curing may improve adhesion between the two layers and may be achieved through a thermally induced curing process.

According to another implementation of the present disclosure, a polymer with variable fiber diameters may be electrospun onto the cathode (or any of the other substrates previously mentioned). The variable fiber diameters may allow fine tuning of the surface roughness and improve the layer's adhesive properties and lateral friction. In some embodiments, polymer fibers having diameters ranging from 0.1-5.0 microns may be used to form the electrospun polymer layer.

What is claimed is:

1. A battery comprising:
an electrolyte;
a cathode; and
an electrospun polymer layer positioned between the electrolyte and the cathode.

2. The battery of claim 1, wherein the electrospun polymer layer has a thickness of 5 microns or less.

3. The battery of claim 1, wherein the electrospun polymer layer comprises one or more polymers selected from the group consisting of: thermoset polyurethane comprising one or more prepolymers, and a chain extender.

4. The battery of claim 1, wherein the electrospun polymer layer comprises a first layer and a second layer, the first layer comprising a polymer that is stable against the cathode but reactive with the electrolyte, and the second layer comprising a polymer that is stable against the electrolyte but reactive with the cathode.

5. The battery of claim 4, wherein the second layer further comprises a tackifier.

6. The battery of claim 1, wherein the electrospun polymer layer comprises a polymer that is stable against both the cathode and the electrolyte.

7. The battery of claim 1, wherein the electrospun polymer layer is formed directly on the cathode.

8. The battery of claim 1, wherein the electrolyte is a solid-state electrolyte.

9. The battery of claim 8, wherein the electrospun polymer layer is formed directly on the solid-state electrolyte.

10. The battery of claim 8, wherein the solid-state electrolyte is selected from the group consisting of: lithium lanthanum zirconium oxide (LLZO), LLTO, a sulfide, LATP, and LiPON.

11. The battery of claim 8, wherein the electrospun polymer layer is formed on a release liner and then transferred to a surface of the cathode or a surface of the solid-state electrolyte.

12. The battery of claim 1, wherein the cathode is a porous cathode containing cathode active material and a polymer or a liquid electrolyte.

13. The battery of claim 1, further comprising a cathode current collector in contact with the cathode.

14. The battery of claim 1, further comprising an anode adjacent to the electrolyte.

15. The battery of claim 14, wherein the anode comprises lithium ions.

16. The battery of claim 14, further comprising an anode current collector in contact with the anode.
